(19) United States
(12) Patent Application Publication
(10) Pub. No.: US 2007/0100092 A1
(43) Pub. Date: May 3, 2007

(54) High optical-performance resin compound

(76) Inventor: Ming-Tsung Chiu, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,406

(22) Filed: Jan. 6, 2006

(30) Foreign Application Priority Data
Nov. 1, 2005 (TW) 94138232

(51) Int. Cl. C08L 63/00

(52) U.S. Cl. 525/533; 528/403

(57) ABSTRACT

The present invention discloses a high optical-performance resin compound, which comprises a hardening agent and a resin material with the average molecular weight of 45˜25000, wherein the backbone of the resin material or the hardening agent has at least one kind of functional groups selected from the class consisting of sulfur atom, benzene ring, and poly-benzene ring. The present invention can obviously enhance the light extraction efficiency and promote the light-emitting efficiency of light-emitting elements.

### BACKGROUND OF THE INVENTION

1. Field of the Invention

The present invention relates to a resin compound, particularly to a high optical-performance resin compound.

2. Description of the Related Art

At present, enhancing the light-emitting efficiency of LED is primarily via promoting the external quantum efficiency thereof, and the promotion of LED external quantum efficiency depends on the promotion of the internal quantum efficiency and light extraction efficiency thereof.

Light extraction efficiency refers to the photon number physically measured outside a light-emitting element after photons are created, absorbed, refracted, and reflected inside the light-emitting element. Owing to internal absorption, uneven current distribution, critical angle-induced loss, the outward-emitted light is only 4% of the light created by the light-emitting layer. In other words, much as the internal quantum efficiency of LED may be very high, the light that can be really received outside is still pretty little. Besides, the light color conversion loss of fluorescent material further reduces the light-emitting efficiency of LED.

At present, the methods of promoting the light extraction efficiency of LED can be divided into two technical domains; one is to utilize various fabrication technologies and chip designs to improve the light-emitting efficiency of LED, which primarily apply to the early-stage quadruple LED, and the focus thereof is to break through the limitation of critical angels; and the other one is to utilize improved packaging materials and packaging designs to promote the light-emitting efficiency of LED, including: high conversion efficiency fluorescent materials, high refractivity and high thermal conductivity packaging materials, improved optical designs of the packaging structures, and technologies of improving the evenness of fluorescent material coating. However, owing to the rectangular appearance of the conventional LED and the large difference between the refractive indices of LED and the packaging epoxy resin, most of the light created inside the LED chip can only be totally reflected inside the chip and can hardly be guided outward from the interior of the chip. Currently, the light-emitting efficiency of LED is improved via modifying the shape of the LED chips; however, the problem of total reflection still remains unsolved. Therefore, developing a packaging resin, which can enhance the light-emitting efficiency, is eagerly anticipated by the industry.

Accordingly, the present invention proposes a high optical-performance resin compound to overcome the problems of the conventional LED packaging resin.

### SUMMARY OF THE INVENTION

The primary objective of the present invention is to provide a high optical-performance resin compound, wherein at least one kind of functional groups selected from the class consisting of sulfur atom, benzene ring and poly-benzene ring is added to the constituent of the resin, so that the resin not only has a high refractivity but also has a superior thermal stability.

The high optical-performance resin compound of the present invention comprises a resin material with the average molecular weight of 45˜25000, and 1˜120 portions (by weight) of a hardening agent is added to 100 portions (by weight) of the resin material; the backbone of the resin material or the hardening agent has at least one kind of functional groups selected from the class consisting of sulfur atom, benzene ring and poly-benzene ring.

To enable the objectives, technical contents, characteristics, and accomplishments of the present invention to be more easily understood, the embodiments of the present invention are to be described below in detail in cooperation with the attached drawings.

### DETAILED DESCRIPTION OF THE INVENTION

The high optical-performance resin compound of the present invention utilizes a resin material and a hardening agent as the raw materials, and a functional group, which can enhance light-emitting efficiency, is added to one of them or both of them; the high optical-performance resin compound of the present invention is installed onto a light-emitting element via enveloping or printing in order to protect the light-emitting element and enhance the light-emitting efficiency thereof, wherein the light-emitting element may be a LED.

The high optical-performance resin compound of the present invention comprises a light-permeable resin material with the average molecular weight of 45˜25000, and 1˜120 portions (by weight) of a hardening agent is added to 100 portions (by weight) of the resin material, and the resin material reacts with the hardening agent at the temperature raging from 50 to 250° C. to obtain a thermosetting resin compound, wherein the backbone of the resin material or the hardening agent has at least one kind of functional groups selected from the class consisting of sulfur atom, benzene ring and poly-benzene ring.

The resin material may be the monomer of the epoxy resin having poly(bi)-thioether, or the prepolymer of the monomer of the epoxy resin having poly(bi)-thioether, or the derivative of the monomer of the epoxy resin having poly(bi)-thioethe, and the monomer of the epoxy resin with bi-thioether (EEW=216 g/eq.) is preferred.

The hardening agent may be selected from the following agent A, agent B and the combination of them:
A. MHHPA (Methylhexahydrophtalic anhydride) or MHHPA having substituents,
B. Polythiol, such as bi-thiol.

Further, a thermal stabilizing agent and an activator may also be added to the resin material; the thermal stabilizing agent can avoid the deterioration of the resin material during the curing process, and the activator can accelerate the reaction between the resin material and the hardening agent. The thermal stabilizing agent may be a phosphite-type one, and the activator may be an ammonium salt-type one.

After the description of the constituents of the high optical-performance resin compound of the present invention, the present invention is to be exemplified below with a specific formula so that the persons skilled in the art can understand, make and use the present invention according to the embodiments.

The efficacy of the present invention is demonstrated with a control experiment, and the constituents of the resin material of the control group (of the conventional technology) are shown in Table. 1.

TABLE 1

| | Constituent | Weight (g) |
|---|---|---|
| Resin material of | Epoxy resin | 100 |
| the control group | Hardening agent (MHHPA) | 97 |
| | Ammonium salt activator | 2 |
| | Phosphite thermal stabilizing | 1 |
| | agent | |

The constituents of the thermosetting resin compound of the present invention are shown in Table.2.

TABLE 2

| | Constituent | Weight (g) |
|---|---|---|
| Resin compound of | Monomer of the epoxy resin with | 100 |
| the present invention | bi-thioether | |
| | Bi-thiol | 30 |
| | Epoxy resin | 20 |
| | Hardening agent (MHHPA) | 16 |
| | Ammonium-salt activator | 4 |
| | Phosphite thermal stabilizing | 3 |
| | agent | |

The resin material of the control group and the resin compound of the present invention are cast onto the LED semi-products to envelop LED chips according to the standard process of the LED packaging factory, and then the semi-products enveloped with the resin material of the control group and the resin compound of the present invention are cured at 160° C.

Next, the orthogonal-direction brightness of the cured LED products is measured with a brightness-test equipment, and the result is shown in Table.3.

TABLE 3

| | Resin compound of the | Resin material of the |
|---|---|---|
| | present invention | control group |
| Test number | (m candela) | (m candela) |
| 1 | 1147 | 667.1 |
| 2 | 903.7 | 728.0 |
| 3 | 882.9 | 759.6 |
| 4 | 1142.2 | 566.4 |
| 5 | 862.6 | 839.4 |
| 6 | 817.4 | 610.6 |
| 7 | 879.9 | 509.3 |
| Average brightness | 947.9 | 668.6 |

It can be seen that the average brightness of the resin compound of the present invention is 41.78% higher than that of the resin material of the control group ((947.9−668.6)/668.6=41.78%).

In the present invention, at least one kind of functional groups selected from the class consisting of sulfur atom, benzene ring and poly-benzene ring is added to the constituents of the resin compound, so that the high optical-performance resin compound of the present invention not only has a high refractivity but also has a superior thermal stability. Therefore, the present invention can effectively overcome the problems of the conventional technologies.

Those embodiments described above are to clarify the present invention to enable the persons skilled in the art to understand, make and use the present invention; however, it is not intended to limit the scope of the present invention, and any equivalent modification and variation according to the spirit of the present invention is to be included within the scope of the claims of the present invention stated below.

What is claimed is:

1. A high optical-performance resin compound, comprising:
a resin material, having the average molecular weight of 45˜25000; and
a hardening agent, wherein the weight ratio of said hardening agent to said resin material is 1˜120 to 100, and the backbone of said resin material or said hardening agent has at least one kind of functional groups selected from the class consisting of sulfur atom, benzene ring and poly-benzene ring.

2. The high optical-performance resin compound according to claim 1, which is installed on light-emitting elements to enhance the optical performance thereof.

3. The high optical-performance resin compound according to claim 2, wherein the installation may be via enveloping or printing.

4. The high optical-performance resin compound according to claim 2, wherein said light-emitting element is a light-emitting diode.

5. The high optical-performance resin compound according to claim 1, wherein said hardening agent is selected from the group consisting of MHHPA (Methylhexahydrophtalic anhydride), MHHPA with substituents, and ploy(bi)-thiol.

6. The high optical-performance resin compound according to claim 1, wherein said resin material is the monomer of the epoxy resin having poly(bi)-thioether, or the prepolymer of the monomer of the epoxy resin having poly(bi)-thioether, or the derivative of the monomer of the epoxy resin having poly(bi)-thioether.

7. The high optical-performance resin compound according to claim 1, wherein the reaction temperature of said resin material and said hardening agent is at the range of from 50 to 250° C.

8. The high optical-performance resin compound according to claim 1, which further comprises a thermal stabilizing agent to avoid the deterioration of said resin material.

9. The high optical-performance resin compound according to claim 8, wherein said thermal stabilizing agent is a phosphite-type one.

10. The high optical-performance resin compound according to claim 1, which further comprises an activator to accelerate the reaction between said resin material and said hardening agent.

11. The high optical-performance resin compound according to claim 10, wherein said activator is an ammonium salt-type one.

12. The high optical-performance resin compound according to claim 1, wherein said resin material is light permeable.

13. The high optical-performance resin compound according to claim 1, wherein said resin material is a thermosetting resin.
